(19) United States
(12) Patent Application Publication
(10) Pub. No.: US 2023/0097073 A1
(43) Pub. Date: Mar. 30, 2023

(54) VEHICLE DISPLAY CONTROL DEVICE, VEHICLE DISPLAY DEVICE, VEHICLE, VEHICLE DISPLAY CONTROL METHOD, AND RECORDING MEDIUM RECORDING VEHICLE DISPLAY CONTROL PROGRAM

(71) Applicant: TOYOTA JIDOSHA KABUSHIKI KAISHA, Toyota-shi (JP)

(72) Inventors: Ryota HAMABE, Nisshin-shi (JP); Keigo HORI, Toyota-shi (JP); Takahiro HIROTA, Nukata-gun (JP); Yoshinori MURATA, Toyota-shi (JP)

(73) Assignee: TOYOTA JIDOSHA KABUSHIKI KAISHA, Toyota-shi (JP)

(21) Appl. No.: 17/879,852

(22) Filed: Aug. 3, 2022

(30) Foreign Application Priority Data
Sep. 24, 2021 (JP) 2021-156127

(51) Int. Cl. B60K 35/00; G06F 3/14

(52) U.S. Cl. CPC B60K 35/00; G06F 3/1423; B60K 2370/182; B60K 2370/52

(57) ABSTRACT

A vehicle display control device that is configured to: switch between a plurality of screen displays containing information relating to a variety of functions; display one of the plurality of screen displays at a display region of a display; and between an on state and an off state of a specific function, change a number of the plurality of screen displays being switched between.

### CROSS-REFERENCE TO RELATED APPLICATION

This application is based on and claims priority under 35 USC 119 from Japanese Patent Application No. 2021-156127 filed on Sep. 24, 2021, the disclosure of which is incorporated by reference herein.

### BACKGROUND

### Technical Field

The present disclosure relates to a vehicle display control device, a vehicle display device, a vehicle, a vehicle display control method, and a recording medium recording a vehicle display control program.

### Related Art

Japanese Patent Application Laid-Open (JP-A) No. 2013-254330 discloses a vehicle information display device that visualizes information provided in the vehicle and displays the information at a display unit. In this vehicle information display device, a screen display at the display unit is switched and displayed in accordance with types of information, and a display method is determined in accordance with the types of information and display priorities.

In the technology recited in JP-A No. 2013-254330, a specific screen display including information relating to a specific function such as, for example, an adaptive cruise control (ACC) function or the like may be displayed at the display unit. When the specific function is turned off, the specific screen display becomes a blank screen. Thus, the specific screen display becomes a redundant screen display.

### SUMMARY

An aspect of the present disclosure is a vehicle display control device, that includes: a memory; and a processor coupled to the memory, the processor being configured to: switch between a plurality of screen displays containing information relating to a variety of functions; display one of the plurality of screen displays at a display region of a display; and between an on state and an off state of a specific function, change a number of the plurality of screen displays being switched between.

### BRIEF DESCRIPTION OF DRAWINGS

FIG. 1 is a schematic view of an example of a front portion of a vehicle cabin interior of a vehicle in which a vehicle display device according to a present exemplary embodiment is employed, seen from the vehicle rear side.

FIG. 2 is a schematic view showing an example of a steering wheel switch.

FIG. 3 is a block diagram showing an example of hardware structures of the vehicle display device according to the present exemplary embodiment.

FIG. 4 is a block diagram showing an example of functional structures of a vehicle display control device according to the present exemplary embodiment.

FIG. 5 is a view showing a display example of a display region of the present exemplary embodiment.

FIG. 6 is a diagram showing an example of plural screen displays to be displayed in a display region when an ACC function is in an off state.

FIG. 7 is a diagram showing an example of a method of inserting a specific screen display.

FIG. 8 is a diagram showing an example of plural screen displays to be displayed in the display region when the ACC function is in an on state.

FIG. 9 is a flowchart showing an example of a flow of display processing according to the present exemplary embodiment.

FIG. 10 is a flowchart showing an example of a flow of screen display number change processing according to the present exemplary embodiment.

FIG. 11 is a diagram showing an alternative example of plural screen displays to be displayed in the display region when the ACC function is in the off state.

FIG. 12 is a diagram showing an alternative example of plural screen displays to be displayed in the display region when the ACC function is in the on state.

### DETAILED DESCRIPTION

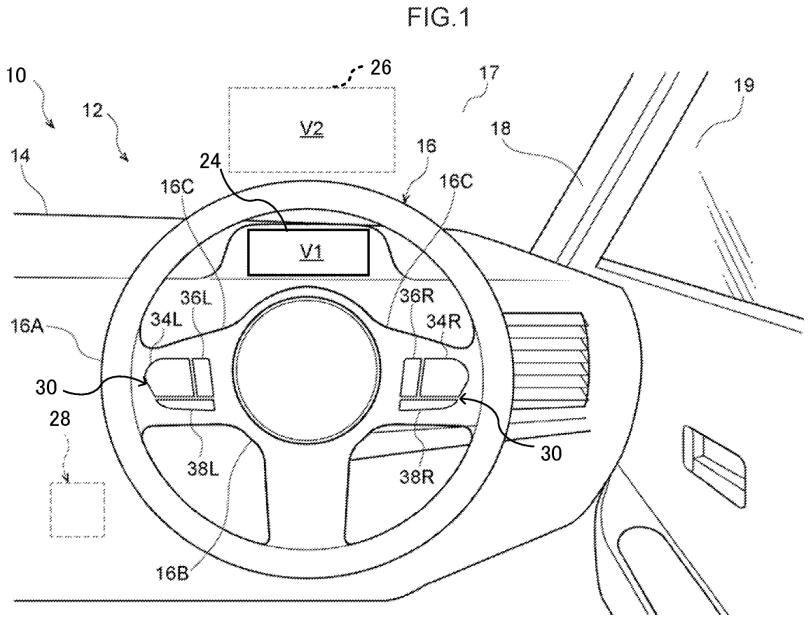

A vehicle 12, in which a vehicle display device 10 according to an exemplary embodiment of the present disclosure is installed, is described with reference to the attached drawings. The arrow UP marked in FIG. 1 indicates the upper side in a vehicle vertical direction and the arrow RH indicates the right side in a vehicle width direction. The vertical direction and left-and-right direction referred to in the descriptions below refer to, respectively, upper and lower in the vehicle vertical direction and left and right in the vehicle width direction.

As shown in FIG. 1, an instrument panel 14 is provided at a front portion of the interior of a vehicle cabin 13 of the vehicle 12. The instrument panel 14 extends in the vehicle width direction, and a steering wheel 16 is provided at the vehicle right side of the instrument panel 14. That is, as an example in the present exemplary embodiment, the vehicle is a right-hand drive car in which the steering wheel 16 is provided at the right side and a driver seat is set at the vehicle right side.

The steering wheel 16 is provided with a rim portion 16A in a substantially annular shape. A hub portion 16B is provided that forms a central portion at the inner periphery side of the rim portion 16A. The right side of the rim portion 16A is connected with the hub portion 16B by a spoke portion 16C, and the left side of the rim portion 16A is connected with the hub portion 16B by another of the spoke portion 16C. The hub portion 16B of the steering wheel 16 is fixed to a vehicle rear side end of a steering shaft. Thus, the steering wheel 16 is turnably supported at the vehicle body. When the steering wheel 16 (the rim portion 16A) is operated by turning, the steering shaft is turned and the vehicle 12 is steered.

Steering wheel switches 30, which are described below, are disposed at the spoke portions 16C of the steering wheel 16. Each steering wheel switch 30 is operable by a vehicle occupant. In FIG. 1, the steering wheel 16 is depicted in a state in which the vehicle is proceeding straight ahead.

The steering wheel switches 30 are provided with a first right operation switch 34R, a second tight operation switch 36R, a right function switching switch 38R, a first left operation switch 34L, a second left operation switch 36L and a left function switching switch 38L. The first right operation switch 34R, second right operation switch 36R and right function switching switch 38R are provided at the spoke portion 16C at the right side. The first left operation switch 34L, second left operation switch 36L and left function switching switch 38L are provided at the spoke portion 16C at the left side.

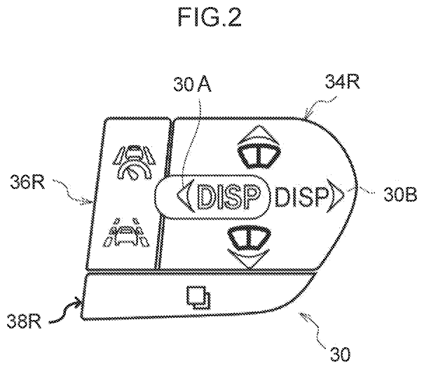

FIG. 2 shows principal portions of one of the steering wheel switches 30 in an elevation view. The steering wheel switches 30 are provided at the steering wheel 16 at the spoke portion 16C at the vehicle width direction right side of the hub portion 16B and the spoke portion 16C at the vehicle width direction left side of the hub portion 16B but, for convenience, only the steering wheel switch 30 at the vehicle width direction right side of the hub portion 16B is described in detail here. The steering wheel switch 30 at the vehicle width direction left side of the hub portion 16B may have similar functions to the steering wheel switch 30 at the vehicle width direction right side of the hub portion 16B. The steering wheel switch 30 at one of the vehicle width direction right side and the vehicle width direction left side of the hub portion 16B may be selectable as an operable switch, or both of the steering wheel switches 30 may be selected as operable switches.

The steering wheel switch 30 shown in FIG. 2 includes the second right operation switch 36R at the side of the steering wheel switch 30 at which the hub portion 16B is disposed (corresponding to the left side of the drawing of FIG. 1) and the first right operation switch 34R at the side of the steering wheel switch 30 at which the rim portion 16A is disposed (corresponding to the right side of the drawing of FIG. 1). The first right operation switch 34R and second right operation switch 36R are structured as, for example, contact sensing-type switches.

In the present exemplary embodiment, the first right operation switch 34R is a switch that is assigned to switching of screen displays, which is described below. The side of the first right operation switch 34R at which the second right operation switch 36R is disposed is assigned to an up switch (a preceding screen switch) 30A, and the opposite side of the first right operation switch 34R from the side thereof at which the second right operation switch 36R is disposed is assigned to a down switch (a succeeding screen switch) 50B.

As shown in FIG. 1, a windshield glass 17 is provided at a front end portion of the instrument panel 14. The windshield glass 17 extends in the vehicle vertical direction and the vehicle width direction, dividing the cabin interior from the cabin exterior.

A vehicle right side end portion of the windshield glass 17 is fixed to a vehicle right side front pillar 18. The front pillar 18 extends in the vehicle vertical direction, and the windshield glass 17 is fixed to a vehicle width direction inner side end portion of the front pillar 18. A front end portion of a front side glass 19 is fixed to a vehicle width direction outer side end portion of the front pillar 18. A vehicle left side end portion of the windshield glass 17 is fixed to a vehicle left side front pillar.

A first display unit (first display) 24 provided with an image display region V1 is provided at the instrument panel 14. The image display region V1 is constituted by an instrument cluster display provided at the vehicle right side of the instrument panel 14, at the vehicle front of the driver seat. The first display unit 24 is connected with various instrument devices mounted in the vehicle 12. The display region V1 is provided at a position within a field of view of a driver in a state in which the eyeline of the driver is oriented to the vehicle front.

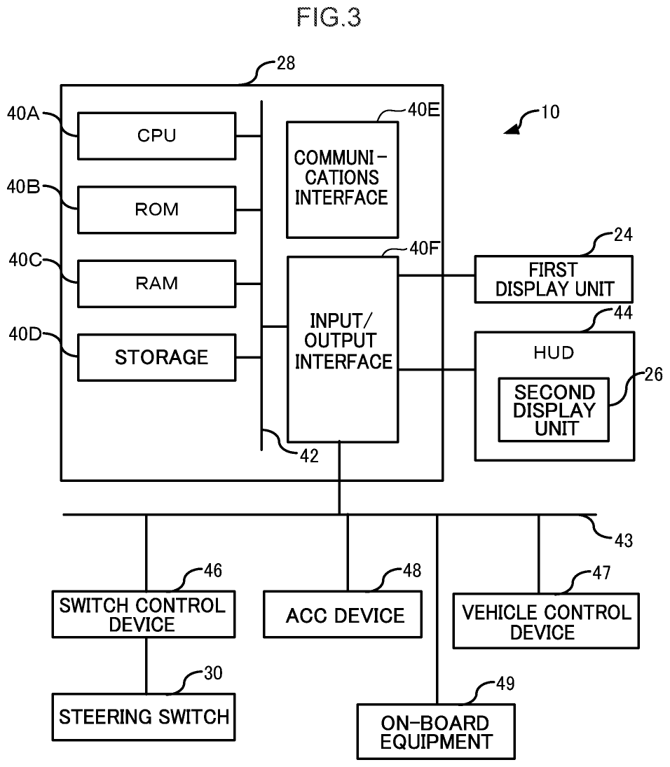

A second display unit (second display) 26 provided with an image display region V2 is provided at the windshield glass 17. The display region V2 is provided at the vehicle upper side relative to the display region V1. The display region V2 is constituted by a projection screen that is projected onto by a head-up display (HUD) device 44 (see FIG. 3). In more detail, the head-up display device 44 is provided at the vehicle front side of the instrument panel 14, and the head-up display device 44 is structured to project images onto the display region V2 of the second display unit 26 of the windshield glass 17. That is, the display region V2 is a portion of the windshield glass 17 that serves as the projection screen of the head-up display device 44.

—Hardware Structures of the Vehicle Display Device 10—

A display control electronic control unit (ECU) 28, which is a control section of the vehicle display device 10, is provided in the vehicle 12 to serve as a vehicle display control device. FIG. 3 is a block diagram showing hardware structures of the vehicle display device 10.

As shown in FIG. 3, the display control ECU 28 of the vehicle display device 10 includes a central processing unit (CPU, or processor) 40A, read-only memory (ROM) 40B, random access memory (RAM) 40C, storage 40D, a communications interface 40E and an input/output interface 40F. These structures are connected to be capable of communicating with one another via a bus 42.

The CPU 40A, which is an example of a hardware processor, is a central arithmetic processing unit that executes various programs and controls respective parts. That is, the CPU 40A loads a program from the ROM 40B or storage 40D, which are examples of memory, and executes the program, using the RAM 40C as a work area. The CPU 40A performs control of the structures described above and various kinds of computational processing in accordance with programs recorded in the ROM 40B or storage 40D.

The ROM 40B stores various programs and various kinds of data. The RAM 40C serves as a work area and temporarily memorizes programs and data. The storage 40D is structured by a hard disk drive (HDD) or solid state drive (SSD). The storage 401) stores various programs, including an operating system, and various kinds of data. In the present exemplary embodiment, the ROM 40B or storage 4013 stores a program for implementing display processing, and various kinds of data and the like.

The communications interface 40E is an interface for the vehicle display device 10 to communicate with a server and other equipment. The communications interface 40E employs a standard such as, for example, Ethernet (registered trademark), LTE, FDDI, Wi-Fi (registered trademark) or the like.

The first display unit 24 and the head-up display device (HUD) 44 are connected to the input/output interface 40F. Images are projected onto the display region V2 of the second display unit 26 by the head-up display device 44.

The input/output interface 40F is connected to a system bus 43 that is routed through the vehicle 12. The system bus 43 is connected to a switch control device 46, a vehicle control device 47, an adaptive cruise control (ACC) device 48, on-board equipment 49 and so forth.

The switch control device 46 is connected to various switches that serve as selection mechanisms and setting mechanisms, including the steering wheel switches 30. The switch control device 46 controls inputs from the various switches. In the present exemplary embodiment, the switch control device 46 detects operation states of the steering wheel switches 30 (the up switch 30A and down switch 30B), and sends outputs to the display control ECU 28 via the system bus 43.

Various control ECUs are installed at the vehicle control device 47, such as a vehicle control ECU that conducts control of the vehicle including running control, an engine ECU that conducts engine control, a steering control ECU that conducts steering control, a braking control ECU that conducts braking control, a transmission control ECU that conducts transmission control, and so forth. The vehicle control device 47 operates in conjunction with the various control ECUs and conducts running control of the vehicle 12.

The ACC device 48 is a device that implements a function that maintains vehicle speed and vehicle-to-vehicle distances from preceding vehicles (an ACC function), which is a running assistance function for maintaining safe distances from vehicles in front. In the vehicle 12, the ACC device 48 may operate as a driving assistance device in conjunction with the vehicle control device 47 and implement driving assistance functions that assist driving operations by a vehicle occupant.

The on-board equipment 49 is various kinds of equipment mounted in the vehicle 12, including various devices such as an air conditioner, an audio system, a car navigation system, a voice input system and the like, and various sensor devices such as cameras, radar, lidar (light detection and ranging/laser imaging detection and ranging), global positioning system (GPS) sensors and the like.

—Functional Structures of the Display Control ECU 28—

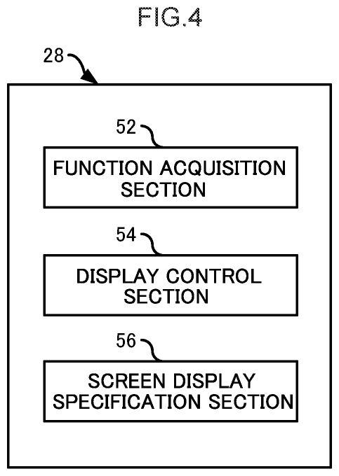

The display control ECU 28 uses the hardware resources described above to implement various functions. The functional structures realized by the display control ECU 28 are described with reference to FIG. 4.

As shown in FIG. 4, the display control ECU 28 includes, as functional structures, a function acquisition section 52, a display control section 54 and a screen display specification section 56. These functional structures are implemented by the CPU 40A reading and executing a program memorized in the ROM 40B or storage 40D.

The function acquisition section 52 acquires on and off states of various functions of the vehicle 12. In the vehicle 12, the vehicle control device 47 monitors respective operation states of control objects such as the ACC device 48, the on-board equipment 49 and the like. When the vehicle control device 47, the ACC device 48, the on-board equipment 49 or the like detects an event at a control object that should be reported to a vehicle occupant, the function acquisition section 52 generates information or an information image relating to the detected event and outputs the information or information image to the display control ECU 28 via the system bus 43. In the present exemplary embodiment, on the basis of on signals of the ACC function inputted from the ACC device 48 to the display control ECU 28, the function acquisition section 52 acquires information indicating whether the ACC function is in an on state or an off state.

The display control section 54 acquires information in accordance with running states and operation states of the vehicle 12 via the system bus 43, displays images according to the acquired information as screen displays at the display region V1 of the first display unit 24 and, via the head-up display device 44, displays the same at the display region V2 of the second display unit 26. In a usual state of the vehicle 12, information to be displayed at the display region V1 of the first display unit 24 and a format of images for displaying the information are set at the display control ECU 28,

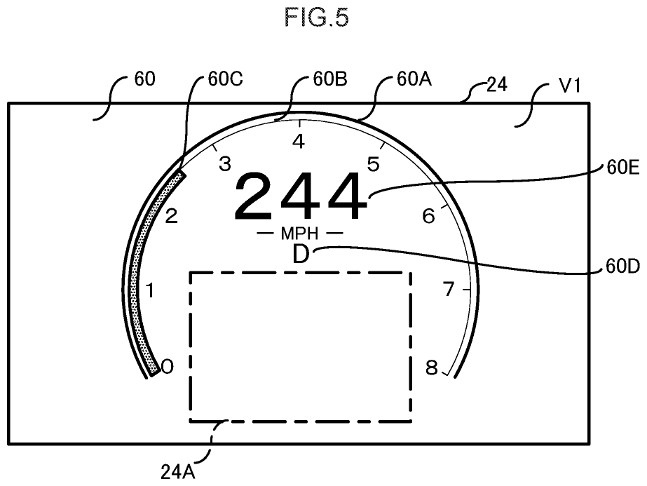

As illustrated in FIG. 5, an image 60 that serves as a screen display to be displayed in the image display region V1 of the first display unit 24 is formed in a substantially rectangular shape. The image 60 is an image showing an engine revolution speed, at a central portion of which a tachometer image 60A representing the engine revolution speed is arranged. A narrow scale bar 60B formed in a circular arc shape is arranged in a circumferential direction in the tachometer image 60A. A colored value bar 60C showing a current engine revolution speed is arranged along the scale bar 60B. The left side end of the value bar 60C in the circumferential direction represents zero rpm, and the engine revolution speed is displayed by the right side end of the value bar 60C lengthening in accordance with the engine revolution speed.

A central portion of the image 60 is a shift display portion 60D, A transmission shift position is displayed at the shift display portion 60D. When the transmission shift position is changed, the display changes. The image 60 to the upper side of the shift display portion 60D is a speed display portion 60E. The speed display portion 60E displays a number according to the speed of the vehicle 12.

In the present exemplary embodiment, a rectangular display region 24A is arranged in the image 60 below the shift display portion 60D, The display region 24A is specified as a portion of the image display region V1 of the first display unit 24. The display control section 54 switches among plural screen displays specified by the screen display specification section 56, which are described below, and displays a screen display in the display region 24A.

When the display control section 54 receives information or an information image relating to an event that should be reported from the vehicle control device 47, ACC device 48, on-board equipment 49 or the like of the vehicle 12, on the basis of the received information, the display control section 54 selects a screen display to be displayed in the display region 24A from the plural screen displays and displays that screen display in the display region 24A. The plural screen displays are specified by the screen display specification section 56 and are memorized in, for example, the storage 40D.

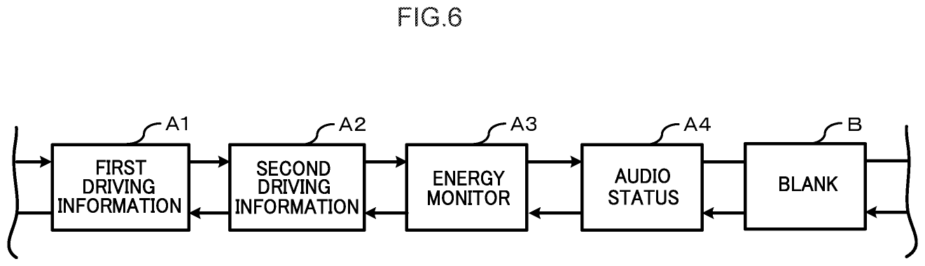

The plural screen displays to be displayed in the display region 24A are now described. As shown in FIG. 6, the screen display specification section 56 specifies, for example, screen displays including screen displays A1 to A4 and a blank screen B to be capable of display at the display region 24A in this sequence. The screen display A1 is a screen display in which first driving information is displayed to provide traffic information, road information and the like received via the communications interface 40E. The screen display A2 is a screen display that displays second (hiving information to provide fuel consumption information and the like of the vehicle 12. The screen display A3 is a screen display that displays an energy monitor to provide information showing relationships of tires, batteries and energy. The screen display A4 is an audio status image for providing audio operation conditions, The blank screen B is a screen display that is constituted as a. black screen or the like, to be shown when a user does not require display of the various kinds of information at the display region 24A.

The plural screen displays including the screen displays A1 o A4 and the blank screen B are switched in sequence and displayed at the display region 24A by the display control section 54 in accordance with operations of the up switch 30A and the down switch 30B. More specifically, each time the up switch 30A is operated, the display control section 54 switches the screen display one at a time in sequence from the screen display A1, the screen display A2, the screen display A3, etc. at the left of FIG. 6 toward the right until a final screen display. Conversely, each time the down switch 30B is operated, the display control section 54 switches the screen display one at a time in sequence from the blank screen B, the screen display A4, the screen display A3, etc. at the right of FIG. 6 toward the left until a first screen display.

When the display control section 54 is switching the screen display to be displayed in the display region 24A, the display control section 54 dynamically switches the display when the up switch 30A or down switch 30B is operated such that the screen displays slide continuously in the horizontal direction of the display region 24A. That is, the display control section 54 causes display such that two screen displays are present in the display region 24A throughout the process of switching the screen display.

When the up switch 30A or down switch 30B is operated by pressing, the display control section 54, for example, successively switches the display among the plural screen displays in sequence until the pressing operation of the up switch 30A or down switch 30B is released. The screen display that is being displayed in the display region 24A at the moment the pressing operation of the up switch 30A or down switch 30B is released is displayed in the display region 24A as the selected screen display.

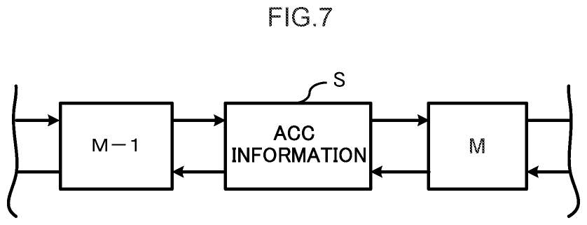

When the function acquisition section 52 acquires information indicating that the ACC function is in the on state, the display control section 54 inserts an ACC screen display providing information relating to the ACC function into the plural screen displays. The ACC screen display serves as a specific screen display S. In the present exemplary embodiment, for example, as illustrated in FIG. 7, the display control section 54 inserts the specific screen display S that is the ACC screen display in the switching sequence between a first screen display M that is currently displayed in the display region 24A and a second screen display M−1 that would be displayed one step preceding (i.e., would be displayed when the down switch 30B is operated once).

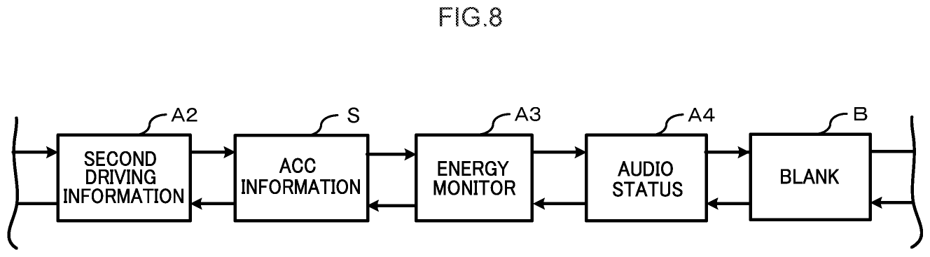

The screen display specification section 56 specifies the ACC screen display as the inserted specific screen display S in the plural screen displays. For example, as shown in FIG. 8, the screen display A3 displaying the energy monitor is the screen display that is currently being displayed at the display region 24A. In this situation, the display control section 54 inserts the ACC screen display serving as the specific screen display S between the screen display A3, which serves as the first screen display M, and the screen display A2 displaying the second driving information, which serves as the second screen display M−1. Thus, the screen display specification section 56 specifies the screen displays such that the screen display can be switched one at a time in sequence from the screen display A1, the screen display A2, the specific screen display S, the screen display A3, etc. at the left of Fig; toward the right until a final screen display. In other words, a total number of screen displays being managed is increased by the screen display specification section 56.

When the function acquisition section 52 acquires information indicating that the ACC function is in the off state, the display control section 54 removes the ACC screen display serving as the specific screen display S that has been inserted into the plural screen displays. Thus, the screen display specification section 56 returns to the specification of screen displays for the usual state of the vehicle 12 that is shown in FIG. 6. In other words, the total number of screen displays being managed is reduced (returned to the original number) by the screen display specification section 56.

—Display Processing—

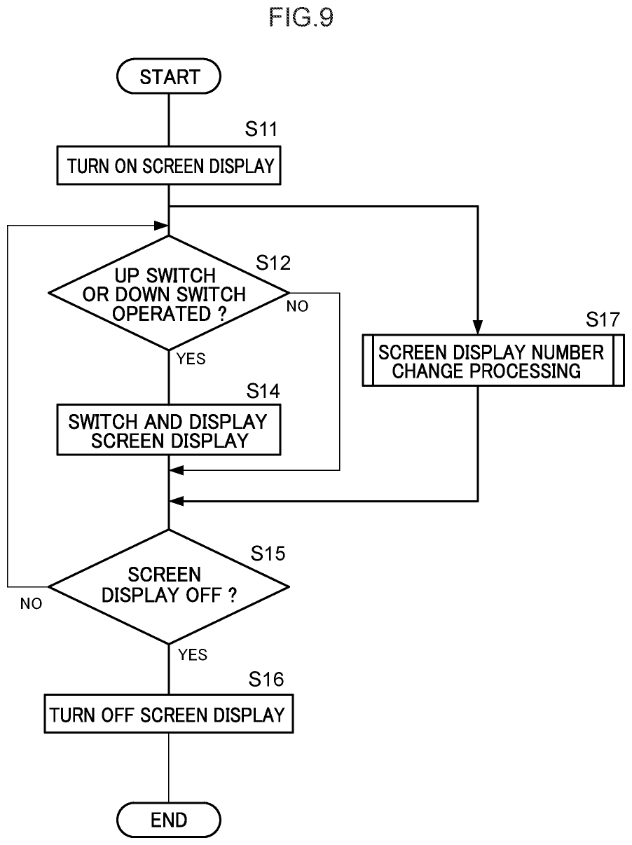

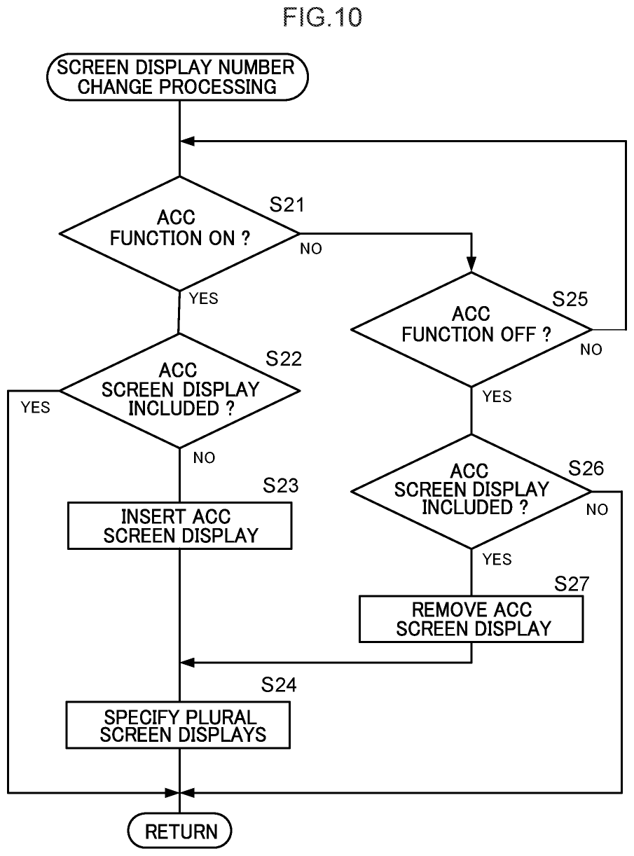

Now, vehicle display control processing that is executed by the display control ECU 28 is described using the flowcharts shown in FIG. 9 and FIG. 10. This display control processing is executed by the CPU 40A loading a display control program from the ROM 40B or storage 40D into the RAM 40C and executing the program. The following processing is started after the display control ECU 28 is given a command to turn on a screen display.

As shown in FIG. 9, in step S11 the display control ECU 28 turns on the screen display (the display region V1) of the first display unit 24 and turns on the head-up display device 44 (the display region V2).

In step S12, the display control section 54 makes a determination as to whether or not the up switch 30A or down switch 30B is operated. If neither is operated (“NO” in step S12), the CPU 40A advances to the processing of step S15. On the other hand, when the up switch 30A or down switch 30B is operated at step S12 (“YES” in step S12), then in step S14, in accordance with the operation of the up switch 30A or down switch 30B, the display control section 54 implements switching and display of the screen display being displayed in the display region 24A.

In step S15, the CPU 40A makes a determination as to whether a command has been given to turn off the screen display. When there is no off command (“NO” in step S15), the CPU 40A returns to the processing of step S12 and repeats the processing from step S12 onward. On the other hand, when there is an off command at step S15 (“YES” in step S15), then in step S16 the display control ECU 28 turns off the screen display (the display region V1) of the first display unit 24 and the head-up display device 44 (the display region V2), and ends this sequence of processing.

When the screen display (the display region V1) of the first display unit 24 and the head-up display device 44 (the display region V2) have been turned on in step S11, in step S17, the display control section 54 executes screen display number change processing in parallel with the processing of step S12.

As shown in FIG. 10, in step S21 the function acquisition section 52 makes a determination as to whether the ACC function is turned on. When the ACC function is on (“YES” in step S21), in step S22 the display control section 54 makes a determination as to whether the ACC screen display serving as the specific screen display S is among the plural screen displays that have been specified by the screen display specification section 56.

When the ACC screen display is absent (“NO” in step S22), in step S23 the display control section 54 inserts the ACC screen display into the plural screen displays as the specific screen display S. In step S24, the screen display specification section 56 specifies the inserted ACC screen display as the specific screen display S among the plural screen displays. When the plural screens have been specified by the screen display specification section 56, the display control section 54 ends the screen display number change processing and proceeds to the processing of step S15 in FIG. 9. On the other hand, when the ACC screen display is present at step S22 (“YES” in step S22), the display control section 54 ends the screen display number change processing and advances to the processing of step S15 in FIG. 9.

When the function acquisition section 52 has determined in step S21 that the ACC function is not on (“NO” in step S21), the function acquisition section 52 makes a determination in step S25 as to whether the ACC function is turned off. When the ACC function is not off (“NO” in step S25), the display control section 54 advances to the processing of step S21 and repeats the processing from step S21 onward.

On the other hand, when the function acquisition section 52 determines in step S25 that the ACC function is off, (“YES” in step S25), in step S26 the display control section 54 makes a determination as to whether the ACC screen display serving as the specific screen display S is among the plural screen displays that have been specified by the screen display specification section 56. When the ACC screen display is absent (“NO” in step S26), the display control section 54 ends the screen display number change processing and advances to the processing of step S15 in FIG. 9.

In step S26, when the ACC screen display is present (“YES” in step S26), in step S27 the display control section 54 removes the ACC screen display serving as the specific screen display S from the plural screen displays. Then, in step S24, the screen display specification section 56 specifies the plural screen displays from which the ACC screen display serving as the specific screen display S has been removed as the plural screen displays to be displayed at the display region 24A. When the plural screens have been specified by the screen display specification section 56, the display control section 54 ends the screen display number change processing and proceeds to the processing of step S15 in FIG. 9.

Thus, by the display control section 54 executing the screen display number change processing of step S17, the number of the plural screen displays to be displayed at the display region 24A is changed between the on state and the off state of the ACC function.

—Operational Effects—

Now, operational effects of the present exemplary embodiment are described.

The display control ECU 28 serving as the vehicle display control device according to the present exemplary embodiment is equipped with the display control section 54 that switches among the plural screen displays containing information relating to a variety of functions and displays a screen display in a display region of a display unit, and that changes the number of the plural screen displays to be switched among between the on state and the off state of the ACC function. Therefore, when the ACC function is in the off state, the number of the plural display screens to be switched among may be decreased. Thus, redundant display screens may be decreased, as a result of which selection of the screen displays by a user may be simplified.

In the display control ECU 28 serving as the vehicle display control device according to the present exemplary embodiment, when the ACC function turns on, the display control section 54 inserts the ACC screen display serving as the specific screen display S, which displays information relating to the ACC function, into the plural screen displays. Thus, a required screen display may be added when necessary. Therefore, the addition of redundant screen displays may be suppressed.

In the display control ECU 28 serving as the vehicle display control device according to the present exemplary embodiment, when the display control section 54 is to display the ACC screen display serving as the specific screen display S in the display region 24A, the display control section 54 inserts the ACC screen display serving as the specific screen display S between the first screen display M that is currently displayed in the display region 24A and the adjacent second screen display M−1 preceding the first screen display M in the switching sequence. Therefore, because the ACC screen display serving as the specific screen display S is adjacent to the currently displayed first screen display M, effort for a user in switching the screen display to display the ACC screen display serving as the specific screen display S may be reduced.

In the display control ECU 28 serving as the vehicle display control device according to the present exemplary embodiment, the display control section 54 switches among the plural screen displays continuously and dynamically. Therefore, a user may see the process of switching between screen displays, and may easily understand that the screen display has been switched.

Because the vehicle display device 10 according to the present exemplary embodiment is equipped with the first display unit 24 and the display control ECU 28, the vehicle display device 10 provides the same operations and effects as the display control ECU 28 described above.

Because the vehicle 12 according to the present exemplary embodiment is equipped with the vehicle display device 10, similarly to the vehicle display device 10, the vehicle 12 provides the same operations and effects as the display control ECU 28 described above.

A vehicle display control method and vehicle display control program according to the present exemplary embodiment also provide the same operations and effects as the display control ECU 28 described above.

### FIRST VARIANT EXAMPLE

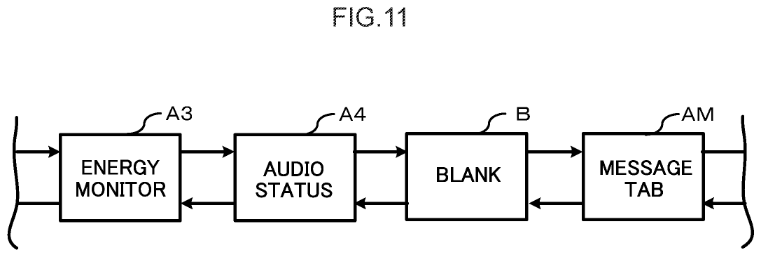

A first variant example is an example in which the ACC screen display serving as the specific display screen S is inserted into the plural screen displays while a message tab screen AM is displayed in the display region 24A. This message tab screen AM is a warning screen display relating to an irregularly occurring event or the like such as, for example, “Oil degraded. Go to a dealer for an oil change.” or the like. As illustrated in FIG. 11, the message tab screen AM is ordinarily inserted adjacent to the blank screen B.

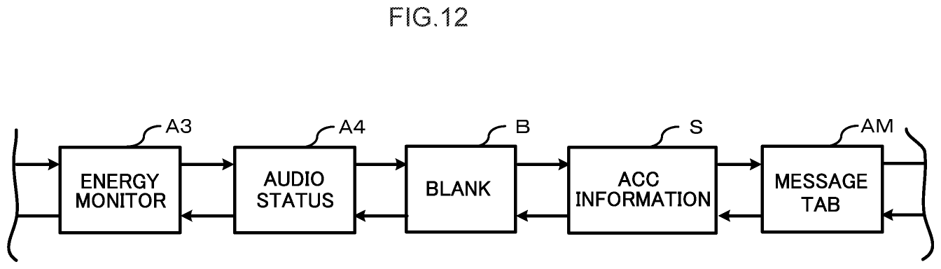

As illustrated in FIG. 12, when information indicating the on state of the ACC function is acquired by the function acquisition section 52 while the message tab screen AM is displayed in the display region 24A, the display control section 54 sets the blank screen B displayed prior to the message tab screen AM in the display region 24A as the first screen display M and sets the message tab screen AM as the second screen display M+1 that would be displayed one step succeeding the blank screen B in the selection sequence. The display control section 54 inserts the ACC screen display serving as the specific display screen S between the first screen display M and the second screen display M+1, and the screen display specification section 56 specifies the inserted ACC screen display serving as the specific screen display S among the plural screen displays.

Thus, because the ACC screen display serving as the specific screen display S may be made adjacent to the message tab screen AM, effort for a user in switching the screen display to display the ACC screen display may be reduced.

In the exemplary embodiment described above, as illustrated in FIG. 7, when the display control section 54 is to display the ACC screen display serving as the specific screen display S in the display region 24A, the display control section 54 inserts the ACC screen display between the first screen display M currently displayed in the display region 24A and the adjacent second screen display M−1 preceding the first screen display M in the selection sequence. However, the present disclosure is not limited thus. For example, the ACC screen display may be inserted between the first screen display M currently displayed in the display region 24A and the adjacent second screen display M+1 succeeding the first screen display M. Further, the insertion position of the specific screen display S may be changed in accordance with display details of the screen displays displayed at the display region 24A. For example, the specific screen display S may be inserted at a position adjacent to a screen display that is displayed in the display region 24A for the most time. In this case, a user may display the specific screen display S simply by operating the up switch 30A or down switch 30B from a screen display that is often looked at. Thus, effort for the user in switching among the screen displays may be reduced.

In the exemplary embodiment described above, the ACC function is described as an example of the specific function, but the specific function of the present disclosure is not limited to the ACC function. For example, the specific function may be a function of an advanced driver assistance system (ADAS) such as a lane keeping assistance (LKA) function implemented by an LKA device or the like. The LKA function is a function that gives warnings of the possibility of deviating from a traffic lane or road, and supports some steering operations to prevent deviation from the traffic lane or road. In this case, the specific screen display S is an LKA screen display containing information relating to the LKA function.

The function acquisition section 52 may acquire on and off states of both the ACC function and the LKA function serving as specific functions. Both the ACC screen display and the LKA screen display may be the specific screen display S, and when each of the functions is turned on, the display control section 54 may insert the screen display of the corresponding function.

In the exemplary embodiment described above, display examples of the display region V1 are described, but this is not limiting, The display region 24A may be provided in the display region V2.

In the exemplary embodiment described above, as shown in FIG. 6, the vehicle 12 in which the energy monitor for providing information showing relationships of tires, batteries and energy is displayed in the display region 24A is, for example, a hybrid electric vehicle (HEV), a plug-in hybrid electric vehicle (PHEV) or the like. However, the vehicle 12 may be a fuel cell electric vehicle (FCEV), a battery electric vehicle (BEV) or the like. The vehicle 12 may further be a vehicle that is equipped with an engine (a reciprocating engine) as a drive source for running. When the vehicle is equipped with an engine, instead of the screen display A3 showing the energy monitor, a screen display showing, for example, eco-drive information may be displayed. It is sufficient that the display control ECU 28 implements displays specified in accordance with the vehicle in which the display control ECU 28 is installed.

The processing executed by the CPU 40A of the present exemplary embodiment, which is shown in FIG. 3, loading and executing software (programs) may be executed by various kinds of processor other than a CPU. Examples of processors in these cases include a PLD (programmable logic device) in which a circuit configuration can be modified after manufacturing, such as an FPGA (field programmable gate array) or the like, a dedicated electronic circuit which is a processor with a circuit configuration that is specially designed to execute specific processing, such as an ASIC (application-specific integrated circuit) or the like, and so forth. The processing may be executed by one of these various kinds of processors, and may be executed by a combination of two or more processors of the same or different kinds (for example, plural FPGAs, a combination of a CPU with an FPGA, or the like). Hardware structures of these various kinds of processors are, to be more specific, electronic circuits combining circuit components such as semiconductor components and the like.

The programs described in the present exemplary embodiment may be provided in a mode of being recorded on a non-transitory recording medium, such as a CD-ROM (compact disc read-only memory), DVD-ROM (digital versatile disc read-only memory), USB (universal serial bus) memory or the like. Modes are also possible in which a program is downloaded from external equipment via a network.

Above, an exemplary embodiment of the present disclosure has been described. The present disclosure is not limited by these descriptions, and numerous modifications outside of these descriptions may be embodied within a technical scope not departing from the gist of the disclosure.

The present disclosure provides a vehicle display control device, a vehicle display device, a vehicle, a vehicle display control method, and a recording medium recording a vehicle display control program that may, by decreasing redundant screen displays, simplify selection of screen displays by a user.

A first aspect of the present disclosure is a vehicle display control device, that includes: a memory; and a processor coupled to the memory, the processor being configured to: switch between a plurality of screen displays containing information relating to a variety of functions; display one of the plurality of screen displays at a display region of a display; and between an on state and an off state of a specific function, change a number of the plurality of screen displays being switched between.

In the vehicle display control device according to the first aspect of the present disclosure, the plural screen displays containing information relating to the variety of functions are switched among and displayed in the display region of the display unit, and the number of the plural screen displays being switched among is changed between the on state and off state of the specific function. Therefore, when the specific function is turned off, the number of the plural screen displays being switched among may be reduced. Thus, redundant screen displays may be decreased, as a result of which selection of the screen displays by a user may be simplified.

A second aspect of the present disclosure is the vehicle display control device according to the first aspect, wherein the processor is configured to, in response to the specific function turning on, insert a specific screen display into the plurality of screen displays, the specific screen display displaying information relating to the specific function.

In the vehicle display control device according to the second aspect of the present disclosure, when the specific function turns on, the specific screen display displaying information relating to the specific function is inserted into the switching sequence of the plural screen displays. Thus, a required screen display may be added when necessary. Therefore, the addition of redundant screen displays may be suppressed.

A third aspect of the present disclosure is the vehicle display control device according to the second aspect, wherein the processor is configured to change a position at which the specific screen display is inserted in accordance with display details of the plurality of screen displays displayed at the display region.

In the vehicle display control device according to the third aspect of the present disclosure, the position at which the specific screen display is inserted is changed in accordance with display details of the screen displays that are displayed in the display region. Therefore, selection of screen displays by a user may be made easier.

A fourth aspect of the present disclosure is the vehicle display control device according to the third aspect, wherein the processor is configured to, in response to the specific screen display being displayed at the display region, insert the specific screen display between a first screen display that is currently displayed at the display region and a second screen display that is adjacent to, either before or after, the first screen display.

In the vehicle display control device according to the fourth aspect of the present disclosure, when the specific screen display is to be displayed in the display region, the specific screen display is inserted between the first screen display that is currently displayed in the display region and the adjacent second screen display that would precede or succeed the first screen display. Therefore, because the specific screen display is adjacent to the currently displayed first screen display, effort for a user in switching the screen display to display the specific screen display may be reduced.

A fifth aspect of the present disclosure is the vehicle display control device according to the fourth aspect, wherein the processor is configured to, in response to the specific screen display being displayed at the display region during display of a message tab screen at the display region, set a blank screen as the first screen display, the blank screen being adjacent to the message tab screen.

In the vehicle display control device according to the fifth aspect of the present disclosure, when the specific screen display is to be displayed in the display region while the message tab screen is being displayed in the display region, the blank screen adjacent to the message tab screen is the first screen display. Therefore, the specific screen display may be made adjacent to the message tab screen, and effort for a user in switching the screen display to display the specific screen display may be reduced.

A sixth aspect of the present disclosure is the vehicle display control device according to any of the first to fifth aspects, wherein the processor is configured to switch between and display the plurality of screen displays at the display region continuously and dynamically.

A vehicle display control device according to the sixth aspect of the present disclosure switches among and displays the plural screen displays at the display region continuously and dynamically. Therefore, a user may see a process of switching between screen displays and may easily understand that a screen display has been switched.

A seventh aspect of the present disclosure is the vehicle display control device according to any of the first to sixth aspects, wherein the specific function is an adaptive cruise control function.

In a vehicle display control device according to the seventh aspect of the present disclosure, the specific function is an adaptive cruise control function. Therefore, the number of the plural screen displays to be switched among may be reduced when the adaptive cruise control function is in the off state. Thus, redundant screen displays mat be decreased, as a result of which selection of screen displays by a user may be simplified.

A eighth aspect of the present disclosure is a vehicle display device, that includes: the vehicle display control device according to any of the first to seventh aspects; and a display including a display region.

A vehicle display device according to an eighth aspect of the present disclosure includes: a display unit including a display region; and a vehicle display control device according to any of the first to seventh aspects. Because the vehicle display control device is a vehicle display control device according to any of the first to seventh aspects, the operations and effects described above are provided.

A ninth aspect of the present disclosure is a vehicle, that includes the vehicle display device according to the eighth aspect.

A vehicle according to the ninth aspect of the present disclosure includes the vehicle display device according to the eighth aspect. Because the vehicle display device is the vehicle display device according to the eighth aspect, and the vehicle display control device is a vehicle display control device according to any of the first to seventh aspects, the operations and effects described above are provided.

A tenth aspect of the present disclosure is a vehicle display control method, that includes: by a processor: switching between a plurality of screen displays containing information relating to a variety of functions; displaying one of the screen displays at a display region of a display; and between an on state and an off state of a specific function, changing a number of the plurality of screen displays being switched between.

A vehicle display control method according to the tenth aspect of the present disclosure includes: switching among plural screen displays containing information relating to a variety of functions and displaying one of the screen displays at a display region of a display unit; and, between an on state and an off state of a specific function, changing the number of the plural screen displays being switched among. Therefore, when the specific function is turned off, the number of the plural screen displays being switched among may be reduced. Thus, redundant screen displays may be decreased, as a result of which selection of the screen displays by a user may be simplified.

A eleventh aspect of the present disclosure is a non-transitory computer readable recording medium storing a vehicle display control program executable by a computer to perform processing, the processing including: switching between a plurality of screen displays containing information relating to a variety of functions; displaying one of the screen displays at a display region of a display; and between an on state and an off state of a specific function, changing the number of the plurality of screen displays being switched between.

The non-transitory computer readable recording medium storing a vehicle display control program according to the eleventh aspect of the present disclosure is executed by a computer to perform processing including: switching among plural screen displays containing information relating to a variety of functions and displaying one of the screen displays at a display region of a display unit; and, between an on state and an off state of a specific function, changing the number of the plural screen displays being switched among. Therefore, when the specific function is turned off, the number of the plural screen displays being switched among may be reduced. Thus, redundant screen displays may be decreased, as a result of which selection of the screen displays by a user may be simplified.

As described above, the vehicle display control device, vehicle display device, vehicle, vehicle display control method, and recording medium recording a vehicle display control program according to the present disclosure may, by decreasing redundant screen displays, simplify selection of screen displays by a user.

What is claimed is:

1. A vehicle display control device, comprising:
a memory; and
a processor coupled to the memory, the processor being configured to:
switch between a plurality of screen displays containing information relating to a variety of functions;
display one of the plurality of screen displays at a display region of a display; and
between an on state and an off state of a specific function, change a number of the plurality of screen displays being switched between.

2. The vehicle display control device according to claim 1, wherein the processor is configured to, in response to the specific function turning on, insert a specific screen display into the plurality of screen displays, the specific screen display displaying information relating to the specific function.

3. The vehicle display control device according to claim 2, wherein the processor is configured to change a position at which the specific screen display is inserted in accordance with display details of the plurality of screen displays displayed at the display region.

4. The vehicle display control device according to claim 3, wherein the processor is configured to, in response to the specific screen display being displayed at the display region, insert the specific screen display between a first screen display that is currently displayed at the display region and a second screen display that is adjacent to, either before or after, the first screen display.

5. The vehicle display control device according to claim 4, wherein the processor is configured to, in response to the specific screen display being displayed at the display region during display of a message tab screen at the display region, set a blank screen as the first screen display, the blank screen being adjacent to the message tab screen.

6. The vehicle display control device according to claim 1, wherein the processor is configured to switch between and display the plurality of screen displays at the display region continuously and dynamically.

7. The vehicle display control device according to claim 1, wherein the specific function is an adaptive cruise control function.

8. A vehicle display device, comprising:
the vehicle display control device according to claim 1; and
a display including a display region.

9. A vehicle, comprising the vehicle display device according to claim 8.

10. A vehicle display control method, comprising:
by a processor:
switching between a plurality of screen displays containing information relating to a variety of functions;
displaying one of the screen displays at a display region of a display, and
between an on state and an off state of a specific function, changing a number of the plurality of screen displays being switched between.

11. The vehicle display control method according to claim 10, wherein, in response to the specific function turning on, a specific screen display is inserted into the plurality of screen displays, the specific screen display displaying information relating to the specific function.

12. The vehicle display control method according to claim 11, wherein a position at which the specific screen display is inserted is changed in accordance with display details of the plurality of screen displays displayed at the display region.

13. A non-transitory computer readable recording medium storing a vehicle display control program executable by a computer to perform processing, the processing comprising:
switching between a plurality of screen displays containing information relating to a variety of functions;
displaying one of the screen displays at a display region of a display; and
between an on state and an off state of a specific function, changing the number of the plurality of screen displays being switched between.

14. The non-transitory computer readable recording medium according to claim 13, wherein, the processing comprises, in response to the specific function turning on, inserting a specific screen display into the plurality of screen displays, the specific screen display displaying information relating to the specific function.

15. The non-transitory computer readable recording medium according to claim 14, wherein the processing comprises changing a position at which the specific screen display is inserted in accordance with display details of the plurality of screen displays displayed at the display region.
